(19) United States
(12) Patent Application Publication
(10) Pub. No.: US 2017/0278263 A1
(43) Pub. Date: Sep. 28, 2017

(54) IMAGE PROCESSING DEVICE, IMAGE PROCESSING METHOD, AND COMPUTER-READABLE RECORDING MEDIUM

(71) Applicant: CASIO COMPUTER CO., LTD., Tokyo (JP)

(72) Inventors: Hitoshi TANAKA, Tokyo (JP); Kenji IWAMOTO, Tokyo (JP)

(73) Assignee: CASIO COMPUTER CO., LTD., Tokyo (JP)

(21) Appl. No.: 15/391,952

(22) Filed: Dec. 28, 2016

(30) Foreign Application Priority Data
Mar. 25, 2016 (JP) 2016-061437

(51) Int. Cl. G06T 7/70; G01B 7/31; G06K 9/20; H04N 5/247; G06K 9/62

(52) U.S. Cl. CPC G06T 7/70; H04N 5/247; G06K 9/6215; G06K 9/209; G01B 7/31

(57) ABSTRACT

The purpose of the present invention is to enable the determination of whether to obtain a special-effect image to be controlled easily. A main body device 20 determines, based on information related to the optical axis directions of two imaging devices 10, whether the relative positional relationship of the respective imaging devices 10 is a predetermined positional relationship. When the relative positional relationship is the predetermined positional relationship, the main body device 20 targets, for synthesis processing, respective images captured by the respective imaging devices 10 in the positional relationship and sets the synthetic format, while when the relative positional relationship is not the predetermined positional relationship, the main body device 20 performs control to set the respective images captured by the respective imaging devices 10 in the positional relationship not to be synthesized without being targeted for the synthesis processing.

### BACKGROUND OF THE INVENTION

1. Field of the Invention

The present invention relates to an image processing device, an image processing method, and a computer-readable storage medium.

2. Description of the Related Art

As a technology for generating a special-effect image (a panoramic image, a 3D image, a 360-degree celestial sphere image, or the like) from plural images, there is known a technology, for example, as disclosed in Japanese Patent Application Laid-Open No. 2005-223812, which is provided with two imaging devices between which the shooting angle and distance can be set by a user, where when a desired mode is selected with a user's operation from various shooting modes for obtaining special-effect images, it is determined whether the shooting angle and distance between the respective imaging devices match the selected mode. When they do not match, a warning is given, while when they match, image processing corresponding to the selected mode is performed to obtain a special-effect image.

### SUMMARY OF THE INVENTION

There is provided an image processing device including a processor, wherein the processor executes: acquiring position information related to a positional relationship between a first imaging device and a second imaging device; determining, based on the acquired position information, whether a relative positional relationship between the first imaging device and the second imaging device satisfies a predetermined condition; and when the relative positional relationship is determined to be satisfied the predetermined condition, setting a synthetic format for respective images captured by the first imaging device and the second imaging device in the positional relationship, wherein the synthetic format is used for synthesizing the respective images.

There is also provided an image processing method used in an image processing device, including: acquiring position information related to a positional relationship between a first imaging device and a second imaging device; determining, based on the acquired position information, whether a relative positional relationship between the first imaging device and the second imaging device satisfies a predetermined condition; and when the relative positional relationship is determined to be satisfied the predetermined condition, setting a synthetic format for respective images captured by the first imaging device and the second imaging device in the positional relationship, wherein the synthetic format is used for synthesizing the respective images.

There is further provided a non-transitory recording medium on which a computer-readable program is recorded, the program causing a computer to execute: acquiring position information related to a positional relationship between a first imaging device and a second imaging device; determining, based on the acquired position information, whether a relative positional relationship between the first imaging device and the second imaging device satisfies a predetermined condition; and when the relative positional relationship is determined to be satisfied the predetermined condition, setting a synthetic format for respective images captured by the first imaging device and the second imaging device in the positional relationship, wherein the synthetic format is used for synthesizing the respective images.

According to the present invention, the determination of whether to obtain a special-effect image can be easily controlled.

### BRIEF DESCRIPTION OF THE SEVERAL VIEWS OF THE DRAWING

FIG. 1A is an appearance diagram representing a state of integrating one of imaging devices 10 and a main body device 20 that constitute a digital camera used as an image processing device.

FIG. 1B is an appearance diagram representing a state of separating between the imaging devices 10 and the main body device 20.

FIG. 2 is a block diagram illustrating schematic configurations of each imaging device 10 and the main body device 20.

FIG. 3A is a diagram for describing a first positional relationship of two imaging devices 10.

FIG. 3B is a side view for describing the first positional relationship of the two imaging devices 10.

FIG. 3C is a diagram for describing a second positional relationship of the two imaging devices 10.

FIG. 3D is a diagram for describing the second positional relationship of the two imaging devices 10.

FIG. 4A is a diagram illustrating a fisheye image obtained by shooting forward in the positional relationship of FIG. 3A.

FIG. 4B is a diagram illustrating a fisheye image obtained by shooting backward in the positional relationship of FIG. 3A.

FIG. 5 is a flowchart for describing the operation of the digital camera (featured operation of a first embodiment) started upon switching to a shooting mode.

FIG. 6 is a flowchart illustrating operation continued from FIG. 5.

FIG. 7A is a block diagram illustrating a schematic configuration of an image processing device (PC) 30 in a second embodiment.

FIG. 7B is a block diagram illustrating a schematic configuration of an imaging device (digital camera) 40 in the second embodiment.

FIG. 8 is a flowchart for describing operation (featured operation of the second embodiment) started upon switching to a shooting mode on the side of the imaging device 40.

FIG. 9 is a flowchart for describing operation (featured operation of the second embodiment) started when a synthesis/playback mode to synthesize two images and playback the synthesized image on the side of the image processing device 30 is specified with a user's operation.

FIG. 10 is a flowchart for describing synthesis processing (step C3 in FIG. 9) in detail.

FIG. 11A is an appearance diagram illustrating a schematic configuration of an image processing device (supporting device: attachment) that supports two imaging devices (digital cameras) 50 in a third embodiment.

FIG. 11B is an appearance diagram illustrating a state where hinges of the image processing device illustrated in FIG. 11A are driven.

FIG. 12A is a diagram illustrating a case where the relative positional relationship (opening/closing angle) of the two imaging devices 50 in the third embodiment is at an opening/closing angle of 0 degrees.

FIG. 12B is a diagram illustrating a case where the relative positional relationship (opening/closing angle) of the two imaging devices 50 in the third embodiment is at an opening/closing angle of 90 degrees.

FIG. 12C is a diagram illustrating a case where the relative positional relationship (opening/closing angle) of the two imaging devices 50 in the third embodiment is at an opening/closing angle of 75 degrees.

FIG. 13 is a block diagram illustrating schematic configurations of the two imaging devices 50 and the supporting device 60 in the third embodiment.

FIG. 14 is a flowchart illustrating operation on the side of the supporting device 60 (featured operation of the third embodiment) started each time shooting is performed on the side of the imaging devices 50.

FIG. 15 is a flowchart illustrating processing for determining the optical axis directions by image analysis to describe a variation of each of the embodiments.

### DETAILED DESCRIPTION OF THE INVENTION

Embodiments of the present invention will be described in detail with reference to the accompanying drawings.

### First Embodiment

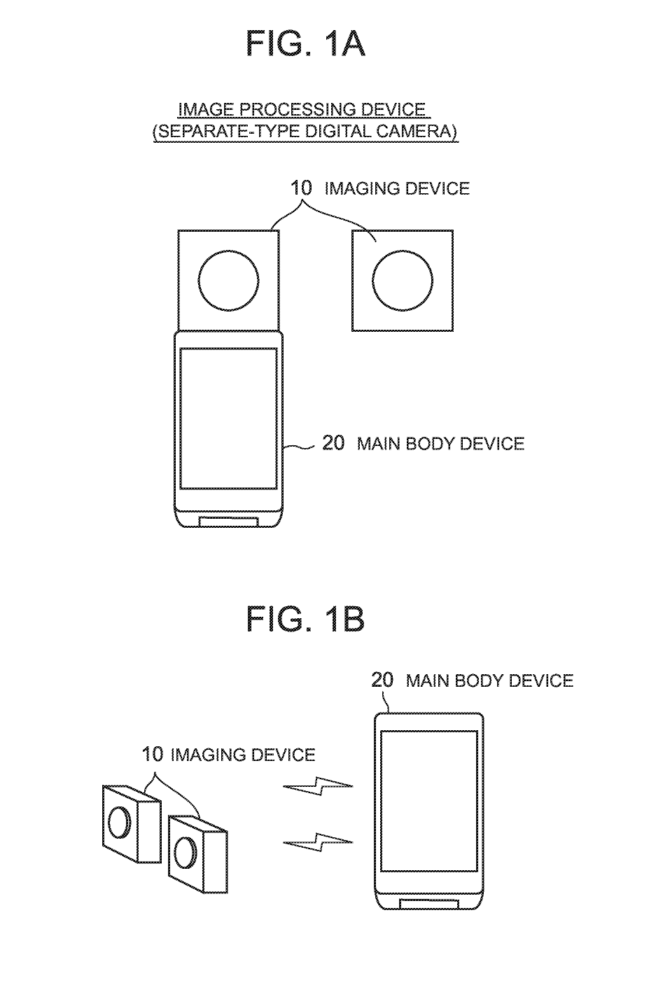

First, a first embodiment of the present invention will be described with reference to FIG. 1 to FIG. 6.

This embodiment exemplifies a case where the present invention is applied to a digital camera as an image processing device. This image processing device is a separate-type digital camera that can be separated into imaging devices 10 each including an imaging unit to be described later and a main body device 20 including a display unit to be described later. FIG. 1 is an appearance diagram of an image processing device (digital camera), where FIG. 1A is a diagram illustrating a state where one of the imaging devices 10 and the main body device 20 are integrated, and FIG. 1B is a diagram illustrating a state where the imaging devices 10 and the main body device 20 are separated. For example, the entire body of each imaging device 10 is shaped into a box, and the first embodiment illustrates a case where two imaging devices 10 having basically the same configuration are provided to enable a user to select shooting using one imaging device or simultaneous shooting using two cameras. However, in the embodiment, the case of shooting using two imaging devices 10 will be described below.

The imaging devices 10 and the main body device 20 that constitute this separate-type digital camera can establish pairing (wireless connection recognition) using wireless communication available for the respective devices. As the wireless communication, for example, wireless LAN (Wi-Fi) or the Bluetooth (registered trademark) is used. Note that the connection method between the imaging devices 10 and the main body device 20 is not limited to the wireless method, and both may be configured to communicate with each other through wired connection using a cable or the like, rather than the wireless method. On the side of the main body device 20, an image shot on the side of each imaging device 10 is received and acquired to display this shot image as a live view image. Note that the shot image in the embodiment is not limited to a stored image, and in a broad sense, it means any image including an image displayed on a live view screen (a live view image, i.e., an image before being stored).

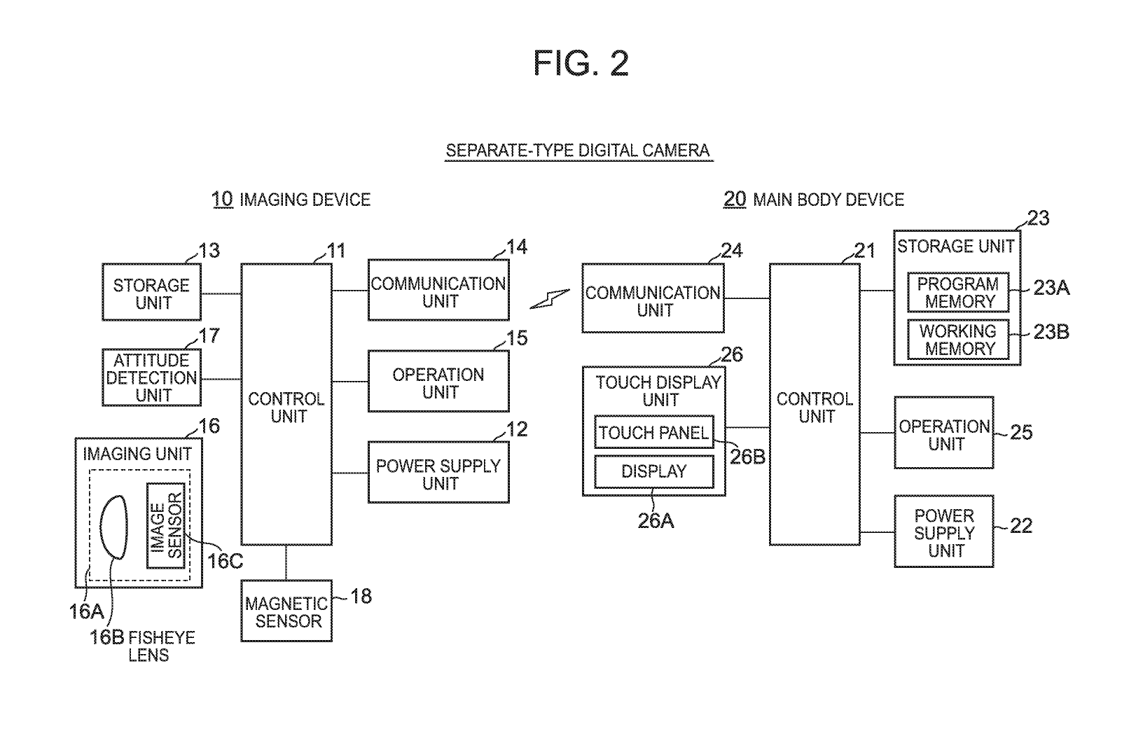

FIG. 2 is a block diagram illustrating schematic configurations of each of the imaging devices 10 and the main body device 20.

In FIG. 2, the imaging device 10 is capable of shooting moving images as well as still images, including a control unit 11, a power supply unit 12, a storage unit 13, a communication unit 14, an operation unit 15, an imaging unit 16, an attitude detection unit 17, and a magnetic sensor 18. The control unit 11 operates by power supply from the power supply unit (secondary battery) 12 to control the entire operation of the imaging device 10 according to various programs in the storage unit 13. A CPU (Central Processing Unit), a memory, and the like, not illustrated, are provided in this control unit 11.

For example, the storage unit 13 is configured to have a ROM, a flash memory, and the like, in which a program for carrying out the embodiment, various applications, and the like are stored. Note that the storage unit 13 may be configured to include a removable, portable memory (recording medium), such as an SD card or a USB memory, or part of the storage unit 13 may include an area of a predetermined external server (not illustrated). The communication unit 14 transmits a shot image to the side of the main body device 20, and receives an operation instruction signal and the like from the main body device 20. The operation unit 15 is equipped with basic operation keys such as a power switch.

The imaging unit 16 is to construct an imaging device capable of shooting a subject with high definition, and a fisheye lens 16B, an image sensor 16C, and the like are provided in a lens unit 16A of this imaging unit 16. Note that a normal imaging lens (not illustrated) and the fisheye lens 16B are exchangeable in the camera of the embodiment. The illustrated example is a state where the fisheye lens 16B is mounted. This fisheye lens 16B is, for example, made up of three lens elements, which is a circular fisheye lens capable of shooting a wide-angle view of substantially 180 degrees. The whole of a wide-angle image (fisheye image) shot with this fisheye lens 16B forms a circular image. In this case, since a projection method is adopted, the wide-angle image (fisheye image) shot with the fisheye lens 16B is distorted more greatly from the center toward the edges.

In other words, since the fisheye lens 16B is a circular fisheye lens capable of shooting a wide-angle view of substantially 180 degrees, the entire fisheye image becomes a circular image, which is not only distorted more greatly from the center toward the edges (periphery), but also reduced in size in the periphery of the fisheye image compared with the center thereof. This makes a user very difficult to visually confirm the details of the content in the periphery even if the user tries to confirm the content. When such a subject image (optical image) is formed on the image sensor (e.g., CMOS or CCD) 16C through the fisheye lens 16B, an image signal (analog signal) photoelectrically converted by this image sensor 16C is converted to a digital signal by an unillustrated A/D conversion unit, transmitted to the side of the main body device 20 after being subjected to predetermined image display processing, and displayed on a monitor.

The attitude detection unit 17 includes, for example, an acceleration sensor and an angular velocity sensor to detect the optical axis direction of the fisheye lens 16B as the attitude of the imaging device 10 at the time of shooting. The acceleration sensor detects an optical axis direction with respect to the direction of gravitational force, and the angular velocity sensor measures rotation angular velocity on which the acceleration sensor does not react to detect the optical axis direction. Attitude information (the optical axis direction of the fisheye lens 16B) detected by this attitude detection unit 17 is transmitted from the communication unit 14 to the side of the main body device 20. The magnetic sensor 18 is provided on the optical axis of the fisheye lens 16B on the side opposite to the fisheye lens 16B (on the back side of the camera), which is a sensor having either one of a magnet or a Hall element to detect an optical axis misalignment of two imaging devices 10 and distance between the two imaging devices 10 based on the intensity and direction of a magnetic field in a manner to be described later.

In FIG. 2, the main body device 20 constitutes a controller of the digital camera, which has a playback function to display images shot with the imaging devices 10 and includes a control unit 21, a power supply unit 22, a storage unit 23, a communication unit 24, an operation unit 25, and a touch display unit 26. The control unit 21 operates by power supply from the power supply unit (secondary battery) 22 to control the entire operation of the main body device 20 according to various programs in the storage unit 23. A CPU (Central Processing Unit), a memory, and the like, not illustrated, are provided in this control unit 21. For example, the storage unit 23 is configured to have a ROM, a flash memory, and the like, including a program memory 23A in which a program for carrying out the embodiment, various applications, and the like are stored, a working memory 23B that temporarily stores various kinds of information (e.g., flags) necessary for this main body device 20 to operate, and the like.

The communication unit 24 exchanges various data with the imaging devices 10. The operation unit 25 is equipped with a power key, a release key, setting keys used to set shooting conditions such as exposure and shutter speed, a cancel key to be described later, and the like. The control unit 21 performs processing according to an input operation signal from this operation unit 25 and transmits the input operation signal to the imaging device 10. The touch display unit 26 has such a structure that a touch panel 26B is laminated on a display 26A such as a high-definition liquid crystal display, and the display screen is used as a monitor screen (live view screen) that displays shot images (fisheye images) in real time or as a playback screen that displays recorded images.

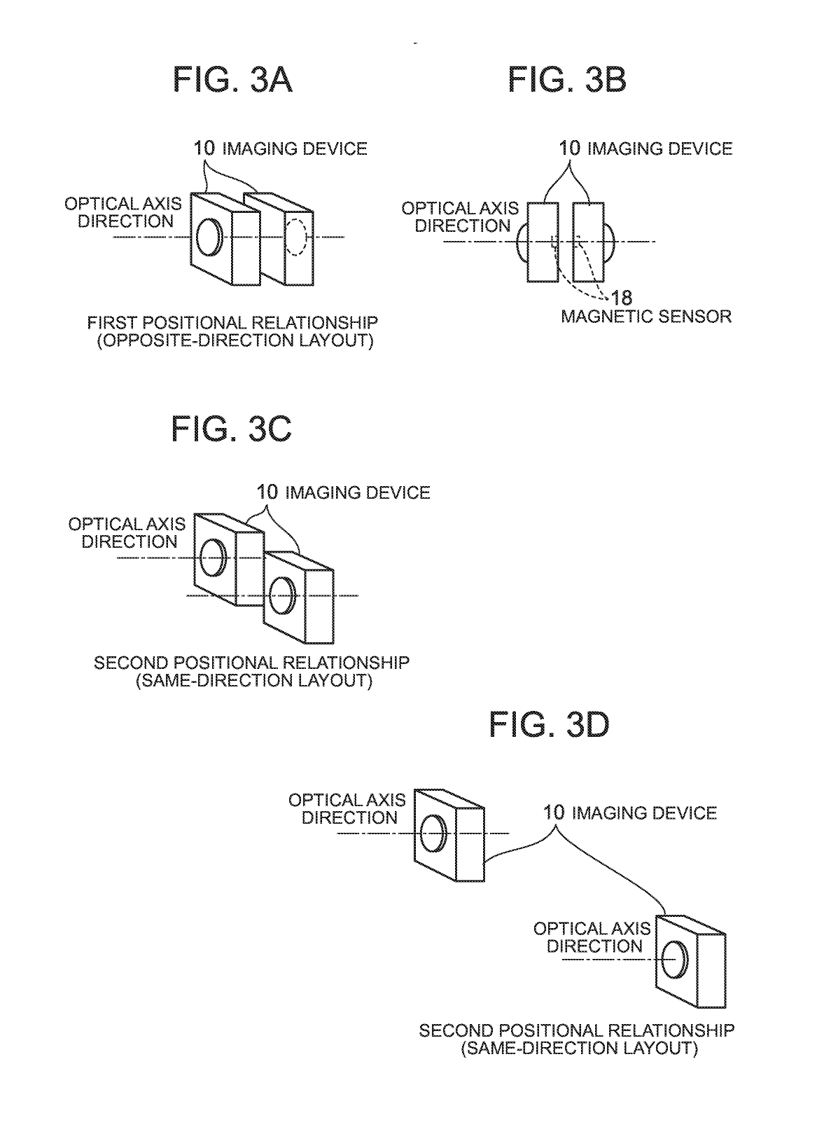

FIG. 3 is a diagram for describing a relative positional relationship of the two imaging devices 10, where FIG. 3A is a perspective view when the two imaging devices 10 are seen from an oblique direction, and FIG. 3B is a side view when the imaging devices 10 are seen from one side alone.

FIGS. 3A and 3B illustrate a positional relationship in which the optical axis directions of the two imaging devices 10 become opposite directions, i.e., an arrangement relationship (first positional relationship) in which the optical axis directions become the opposite directions or directions within a predetermined acceptable range with respect to the opposite directions in such a state that the optical axis direction and gravitational direction of each imaging device 10 are perpendicular to each other or within a predetermined acceptable range with respect to the perpendicularity. The illustrated example further indicates not only a case where the optical axes of the respective imaging devices 10 coincide with each other or substantially coincide with each other (in a case where the optical axis misalignment falls within an acceptable range) in this first positional relationship (opposite-direction positional relationship), but also a case where the backsides of the two imaging devices 10 are in contact with each other or come close to each other.

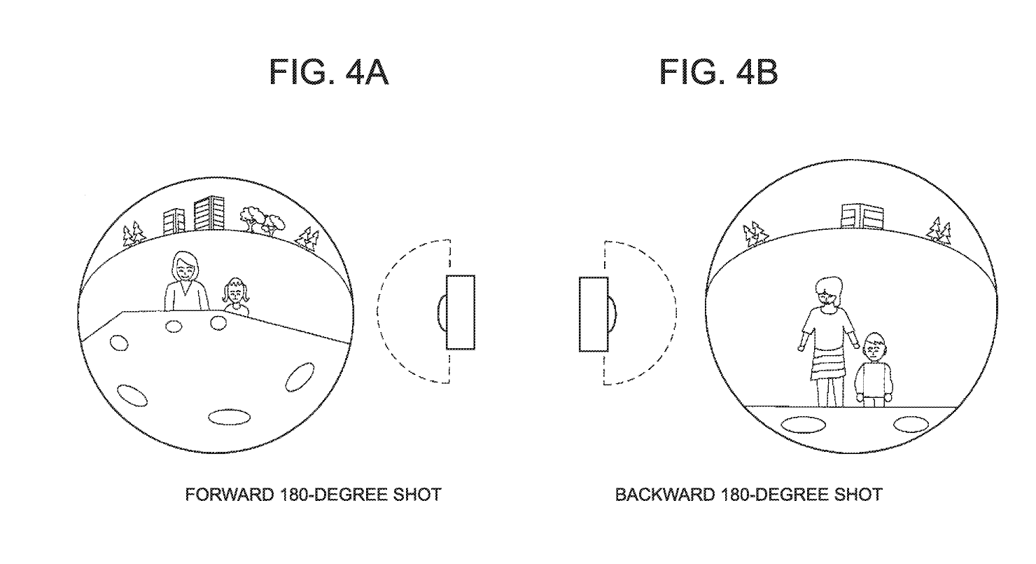

FIG. 4 illustrates examples of fisheye images shot in the first positional relationship (opposite-direction positional relationship) illustrated in FIGS. 3A and 3B, where FIG. 4A illustrates an image (fisheye image) shot with one of the two imaging devices 10, and FIG. 4B illustrates an image (fisheye image) shot with the other imaging device 10. When each imaging device 10 performs shooting using the fisheye lens 16B in this positional relationship, a fisheye image shot forward at 180 degrees and a fisheye image shot backward at 180 degrees are obtained. In other words, an image with a shooting range of 360 degrees (a 360-degree celestial sphere image) can be obtained as a whole from the forward 180-degree shot and the backward 180-degree shot.

FIG. 3C illustrates a positional relationship in which the optical axis directions of the two imaging devices 10 become the same directions, i.e., an arrangement relationship (second positional relationship) in which the optical axis directions become the same directions or directions within a predetermined acceptable range with respect to the same direction in such a state that the optical axis direction and gravitational direction of each imaging device 10 are perpendicular to each other or within a predetermined acceptable range with respect to the perpendicularity. The illustrated example further indicates a state where the distance between the respective imaging devices 10 is narrowed down to come close to each other (first distance or less) in this second positional relationship (same-direction positional relationship).

When each imaging device 10 performs shooting in this positional relationship, each image shot from a different viewpoint in the same shooting range (each image with a parallax effect) can be obtained. FIG. 3D illustrates a case where shooting is performed by widening the distance between the respective imaging devices 10 in the second positional relationship (same-direction positional relationship). Note that the first distance and the second distance have a relation of first distance <second distance. When the respective imaging devices 10 perform shooting in such a positional relationship, images different in shooting range or images with a partial (peripheral) overlap in the shooting ranges can be obtained.

The main body device 20 acquires attitude information (optical axis direction) detected by the attitude detection unit 17 from each of the two imaging devices 10, and determines a relative positional relationship between the two imaging devices 10. Then, the main body device 20 performs control in such a manner that, when the positional relationship satisfies a predetermined condition, a synthetic format is set for images shot with the respective imaging devices.

For example, when the relative positional relationship between the two imaging devices 10 is a predetermined positional relationship, i.e., any of the relative positional relationships illustrated in FIGS. 3A, 3C, and 3D, a synthetic format using respective images shot in the predetermined positional relationship as images to be synthesized is set, while when the positional relationship is not any of the predetermined relationships, respective shot images are set as images not to be synthesized (normal images) without setting the shot images as synthetic targets.

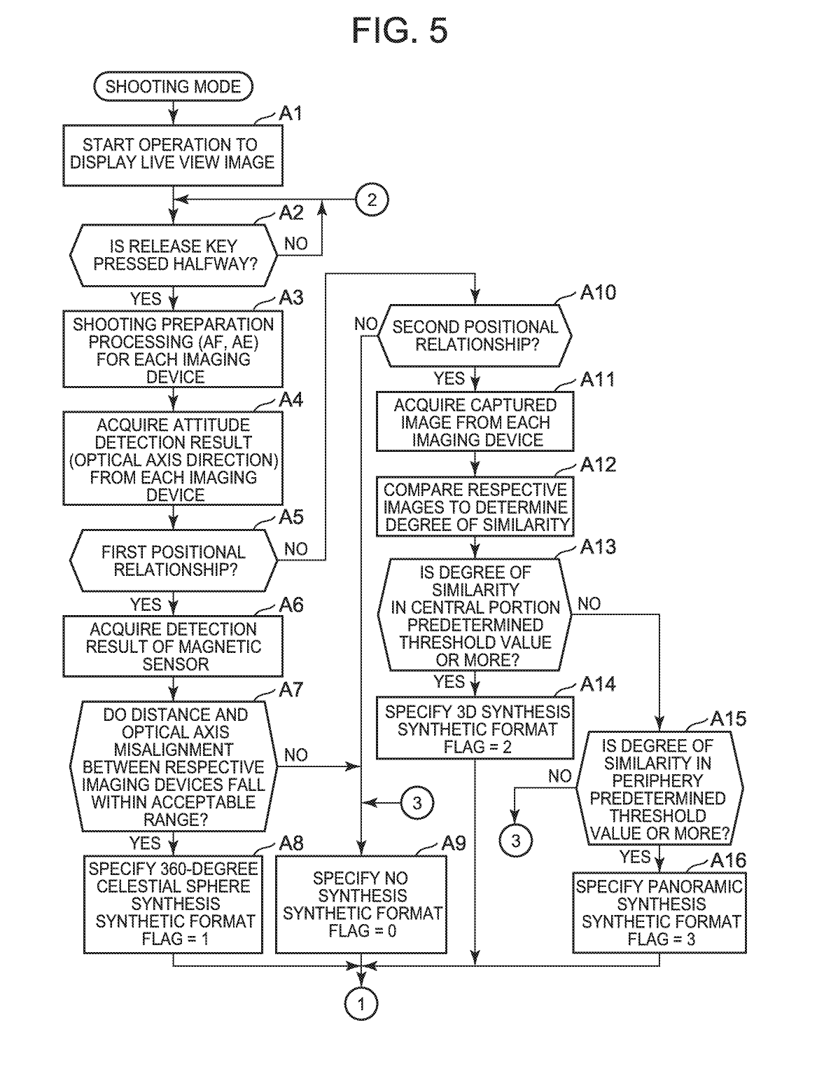

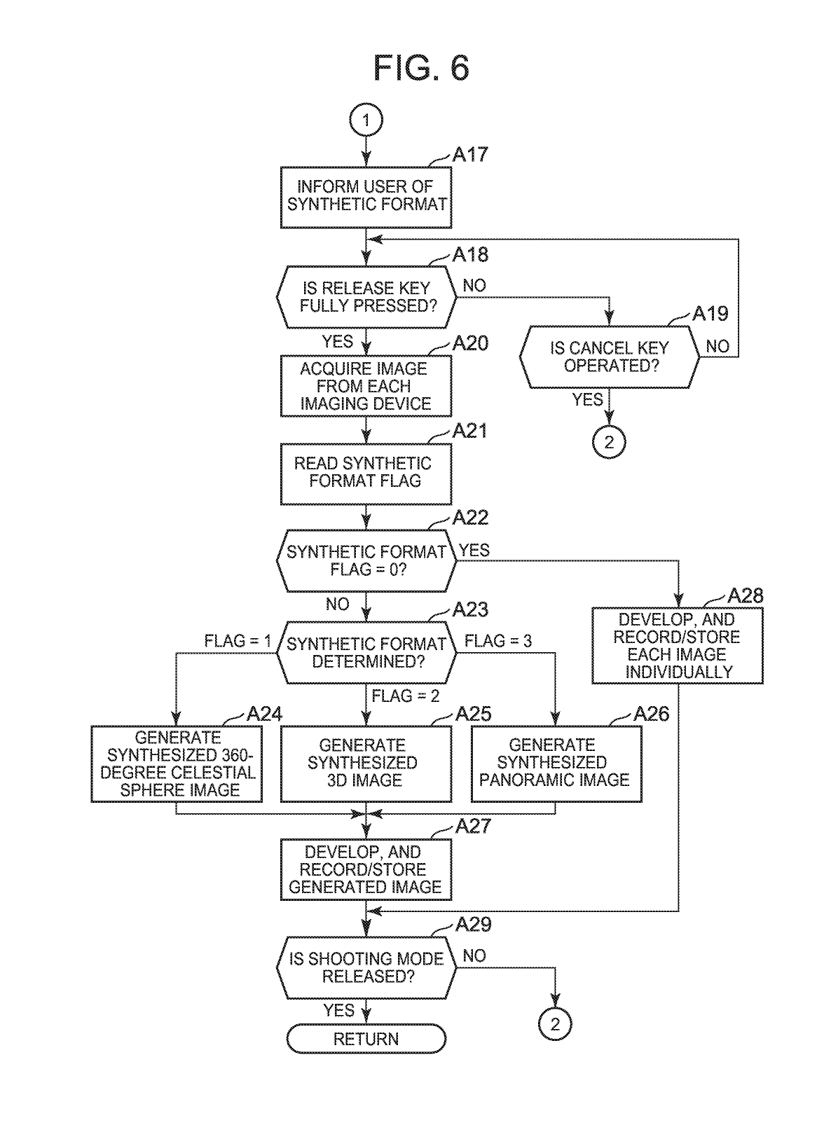

Next, the general idea of the operation of the image processing device (digital camera) in the first embodiment will be described with reference to flowcharts illustrated in FIG. 5 and FIG. 6. Here, each of the functions described in these flowcharts is stored in the form of readable program code, and the operation is carried out sequentially according to this program code. Operation according to the above program code transmitted through a transmission medium such as a network can also be carried out sequentially. The same applies to other embodiments to be described later. Any program/data externally supplied through the transmission medium, as well as the recording medium, can also be used to carry out operation specific to the embodiment. Note that FIG. 5 and FIG. 6 are flowcharts illustrating an outline of featured operation of the embodiment in the entire operation of the image processing device (digital camera), and when getting out of the flows of FIG. 5 and FIG. 6, the procedure returns to a main flow (not illustrated) of the entire operation.

FIG. 5 and FIG. 6 are flowcharts for describing the operation of the digital camera started upon switching to a shooting mode (featured operation of the first embodiment).

First, the control unit 21 on the side of the main body device 20 starts operation to display, on the touch display unit 26, an image acquired from each imaging device 10 as a live view image in a state of being communicable with the two imaging devices 10 (step A1 in FIG. 5). In this state, it is checked whether the release key is pressed halfway (step A2), and when it is checked not to be pressed halfway (NO in step A2), the control unit 21 waits for the half press. When the release key is pressed halfway (YES in step A2), each imaging device 10 is instructed to perform shooting preparation processing such as AF (autofocus processing) and AE (automatic exposure processing) (step A3).

Then, attitude information (optical axis direction) is acquired from each imaging device 10 as the detection result of the attitude detection unit 17 (step A4), and it is checked whether the optical axis directions of the respective imaging devices 10 are in the first positional relationship (opposite positional relationship) (step A5). When the optical axis directions are in the first positional relationship (YES in step A5), the detection results (the intensity and direction of a magnetic field) of the magnetic sensor 18 are acquired from the imaging device 10 (step A6), and based on the detection results (the intensity and direction of the magnetic field), it is checked not only whether the respective imaging devices 10 are too far away from each other (i.e., whether the respective imaging devices 10 fall within an acceptable range), but also whether the optical axis misalignment falls within an acceptable range (step A7). Here, when the respective imaging devices 10 are too far away from each other and the optical axis misalignment is too much (NO in step A7), information for setting a synthetic format flag (not illustrated) to “0” as information for specifying no synthesis not to synthesize the respective images captured by the two imaging devices 10 without being targeted for the synthesis processing (step A9).

Further, in the first positional relationship (YES in step A5), when the distance between the respective imaging devices 10 and the optical axis misalignment fall within the acceptable ranges (YES in step A7), it is determined that the two imaging devices 10 are so located that the backsides thereof will be in contact with or come close to each other as illustrated in FIG. 3A (i.e., the two imaging devices 10 are in the predetermined positional relationship) to target, for the synthesis processing, the respective images captured by the two imaging devices 10 and set the synthetic format (step A8). In this case, “1” is set as the synthetic format suitable for the first positional relationship, i.e., as information for specifying 360-degree celestial sphere synthesis in the synthetic format flag. For example, the synthetic format flag is set to “1” as information for specifying synthesis processing to put together the fisheye image shot forward at 180 degrees as illustrated in FIG. 4A and the fisheye image shot backward at 180 degrees as illustrated in FIG. 4B in order to obtain an image with a shooting range of 360 degrees (a 360-degree celestial sphere image).

On the other hand, when the optical axis directions of the respective imaging devices 10 are not in the first positional relationship (NO in step A5), it is checked whether the optical axis directions are in the second positional relationship (same-direction positional relationship) (step A10). Here, when it is not even in the second positional relationship (NO in step A10), the synthetic format flag is set to “0” not to synthesize the respective images captured by the two imaging devices 10 (step A9), while when it is in the second positional relationship (YES in step A10), captured images are acquired from the two imaging devices 10 (step A11), the respective images are analyzed, and the analysis results are compared to determine the degree of similarity between both (step A12) in order to check whether the degree of similarity in a central portion of each image is a predetermined threshold value or more (whether the degree of similarity is high) (step A13).

Here, when the degree of similarity in the central portion of each image is the predetermined threshold value or more, i.e., when the degree of similarity between both is high (YES in step A13), it is determined that the two imaging devices 10 are in the state as illustrated in FIG. 3C, where the distance between the respective imaging devices 10 is narrowed down to come close to each other (first distance or less) in the second positional relationship, and in the state where respective images are to be shot from different viewpoints in the same shooting range (i.e., the images are in a predetermined positional relationship). In this case, the procedure proceeds to step A14 in which the synthetic format flag is set to “2” as information for specifying 3D (three-dimensional) synthesis processing using one image as a left-eye image and the other image as a right-eye image.

Further, in the second positional relationship (YES in step A10), when the degree of similarity in the central portion of each image is less than the predetermined threshold value and hence the degree of similarity in the portion is not so high (NO in step A13), it is checked whether the degree of similarity in the periphery of each image is a predetermined threshold value or more (i.e., whether the degree of similarity is high) (step A15). Here, when the degree of similarity in the periphery is also less than the predetermined threshold value (NO in step A15), the synthetic format flag is set to “0” to set respective images captured by the two imaging devices 10 not to be synthesized (step A9), while when the degree of similarity in the periphery is the predetermined threshold value or more and hence the degree of similarity is high (YES in step A15), it is determined that the respective imaging devices 10 are in a state of being arranged by widening the distance therebetween (second distance or more) as illustrated in FIG. 3D, and a state of performing shooting by widening the shooting range (in the predetermined positional relationship), and the procedure proceeds to step A16 in which the synthetic format flag is set to “3” as information for specifying wide-angle, panoramic synthesis processing to line up two images side by side.

Thus, when the synthetic format suitable for the positional relationship is set according to the relative positional relationship between the respective imaging devices 10, the procedure moves to the flow of FIG. 6 to display an icon or a message for the set synthetic format on the live view screen to inform a user thereof (step A17). In other words, no synthesis is informed, or any of 360-degree celestial sphere synthesis, three-dimensional synthesis, and panoramic synthesis is informed. In this state, it is checked whether the release key is fully pressed (step A18), or whether the cancel key to cancel the set synthetic format is operated (step A19).

When the cancel key is operated (YES in step A19), the procedure returns to step A2 in FIG. 5 to cancel the set synthetic format, while when the release key is fully pressed (YES in step A18), each image captured by each imaging device 10 at the time of the full press operation is acquired (step A20), the above-described synthetic format flag is read (step A21), and it is checked whether the synthetic format flag is “0” (step A23). Here, when the synthetic format flag is “0” (YES in step A22), processing for recording/storing each of images captured by the two imaging devices 10 on a recording medium in the storage unit 23 after each image is subjected to development and conversion to a standard-sized file individually in order to set each image not to be synthesized without being targeted for the synthesis processing (step A28).

When the synthetic format flag is not “0” (NO in step A22), the synthetic format is further determined (step A23). When the synthetic format flag is “1,” 360-degree celestial sphere synthesis processing is performed to put together respective images captured by the two imaging devices 10 so as to generate a synthesized 360-degree celestial sphere image (step A24). In this case, the synthesis processing is performed after processing for correcting a distortion of each fisheye image captured in the embodiment is performed to generate an image without any distortion (the same applies hereinafter). When the synthetic format flag is “2,” 3D synthesis processing is performed to generate a synthesized 3D image (step A25). When the synthetic format flag is “3,” panoramic synthesis processing is performed to generate a synthesized panoramic image (step A26). The synthesized image thus generated is recorded/stored on the recording medium in the storage unit 23 after being subjected to development and conversion to a file of a predetermined size (step A27). Whether to record/store only the synthesized image or to record/store respective fisheye images together with the synthesized image is determined according to the storage format arbitrarily set in advance with a user's operation.

When the processing for recording/storing the image(s) is thus completed, it is checked whether the shooting mode is released (step A29). When the shooting mode remains the same (NO in step A29), the procedure returns to step A2 in FIG. 5 to repeat the above-mentioned operation, while when the shooting mode is released (YES in step A29), the procedure exits from the flows of FIG. 5 and FIG. 6.

As described above, in the first embodiment, the main body device 20 determines, based on the information related to the optical axis directions of the two imaging devices 10, whether the relative positional relationship between the respective imaging devices 10 is a predetermined positional relationship. Since the main body device 20 performs control in such a manner that, when it is the predetermined positional relationship, each image captured by each imaging device 10 in the positional relationship is targeted for synthesis processing and the synthetic format is set, while when it is not the predetermined positional relationship, each image captured by each imaging device 10 in the positional relationship is set not to be synthesized without being targeted for the synthesis processing, the determination of whether to obtain an image captured by special-effect shooting can be easily controlled without any instruction given with a user's operation. This enables the main body device 20 to cope with shooting easily using various special effects and other normal shooting.

Further, since the first positional relationship in which the optical axis directions of the respective imaging devices 10 are opposite directions or directions within an acceptable range with respect to the opposite directions, and the second positional relationship in which the optical axis directions of the respective imaging devices 10 are the same directions or directions within an acceptable range with respect to the same direction are set as predetermined positional relationships, the relative positional relationship of the respective imaging devices 10 becomes a positional relationship suitable for 360-degree celestial sphere synthesis, 3D synthesis, or panoramic synthesis, and easy for the user to understand.

When the respective imaging devices 10 are in the first positional relationship, the main body device 20 further determines whether the optical axis misalignment of the respective imaging devices 10 falls within an acceptable range, and when it is within the acceptable range, the main body device 20 determines that the respective imaging devices 10 are in the predetermined positional relationship. Thus, a positional relationship suitable for predetermined synthesis processing can be specified properly.

When the respective imaging devices 10 are in the second positional relationship, the main body device 20 further determines whether the distance between the respective imaging devices 10 is predetermined distance, and when it is the predetermined distance, the main body device 20 determines that the respective imaging devices 10 are in the predetermined positional relationship. Thus, a positional relationship suitable for predetermined synthesis processing can be specified properly.

When the respective imaging devices 10 are in the second positional relationship, the main body device 20 further analyzes each image captured by each imaging device 10 to determine a degree of similarity between images in order to determine, based on this degree of similarity, whether the distance between the respective imaging devices 10 is predetermined distance. Thus, it can be determined whether the distance is the predetermined distance merely by analyzing each image without actually measuring the distance between the respective imaging devices 10.

When analyzing each image to determine whether to be the predetermined distance, if the degree of similarity in the central portion of each image is high, the main body device 20 will determine that the distance is the predetermined distance. Thus, distance suitable for predetermined synthesis processing can be specified properly.

When analyzing each image to determine whether to be the predetermined distance, if the degree of similarity in the periphery of each image is high, the main body device 20 will determine that the distance is the predetermined distance. Thus, distance suitable for predetermined synthesis processing can be specified properly.

When the optical axis misalignment of the respective imaging devices 10 in the first positional relationship falls within the acceptable range, the main body device 20 sets such a synthetic format as to generate a 360-degree celestial sphere image from respective fisheye images captured by the respective imaging devices 10. Thus, the positional relationship suitable for synthesis processing to generate a 360-degree celestial sphere image can be specified properly.

When the distance between the respective imaging devices 10 in the second positional relationship is the predetermined distance, the main body device 20 sets such a synthetic format as to generate a panoramic image or three dimensional image from respective images captured by the respective imaging devices 10 depending on the magnitude of the predetermined distance. Thus, the positional relationship suitable for synthesis processing to generate a panoramic image or a three dimensional image can be specified properly.

Since the main body device 20 performs synthesis processing according to the set synthetic format, an image synthesized at the time of shooting can be recorded/stored.

Since the main body device 20 informs the user of the set synthetic format, the user can check on the set synthetic format and change the synthetic format merely by changing the arrangement of the respective imaging devices 10.

Since the main body device 20 acquires information related to the optical axis direction from the attitude detection unit 17 provided in each imaging device 10, an accurate optical axis direction can be acquired.

<Variation 1>

In the first embodiment mentioned above, the case where the present invention is applied to the separate-type digital camera that can be separated into the imaging devices 10 and the main body device 20 is illustrated, but the present invention may also be applied to cameras (e.g., compact cameras) in each of which the imaging device 10 and the main body device 20 are integrated. In this case, the configuration may be such that one of two cameras is a master camera and the other is a slave camera, both of which can perform short-distance communication with each other. In other words, the master camera performs shooting preparation processing with a half-press of the release key, and instructs the slave camera to perform shooting preparation processing. Further, based on the optical axis direction acquired from the own camera and the optical axis direction acquired from the slave camera, the master camera may determine a relative positional relationship of the two cameras. Like in the first embodiment, the determination of whether to obtain a special-effect shot image from respective images captured by the two cameras can be easily controlled even between the master camera and the slave camera without any instruction from the user.

In the first embodiment mentioned above, when the optical axis directions of the respective imaging devices 10 are in the second positional relationship, if the degree of similarity in the central portion of each image is the predetermined threshold value or more and hence the degree of similarity is high (YES in step A13 of FIG. 5), the two imaging devices 10 move to step A14 to set the synthetic format flag to “2” in order to specify 3D synthesis processing, but the two imaging devices 10 may also move to step A14 on condition that the degree of similarity in the periphery of each image is high as a result of the determination of whether the degree of similarity in the periphery is a predetermined threshold value or more and hence the degree of similarity is high, in addition to the degree of similarity in the central portion of each image.

In the first embodiment mentioned above, each image captured by each imaging device 10 is analyzed to determine, based on the degree of similarity, whether the distance between the respective imaging devices 10 is predetermined distance, but the distance between the respective imaging devices 10 may, of course, be measured to determine whether the distance is the predetermined distance. For example, a short-distance communication unit may be provided in each imaging device 10 in addition to a GPS (Global Positioning System) function provided in each imaging device 10 to determine whether the distance between the respective imaging devices 10 is the predetermined distance based on whether each imaging device 10 exists within a communicable area.

Further, in the first embodiment mentioned above, the case where the present invention is applied to the separate-type digital camera as the image processing device that can be separated into the two imaging devices 10 and the main body device 20 is illustrated, but it may be a digital camera with two imaging devices 10 integrally incorporated in the main body device 20. Even in this case, it is only necessary to construct each imaging device 10 to make the optical axis direction variable (i.e., to have a structure variable between the first positional relationship and the second positional relationship).

### Second Embodiment

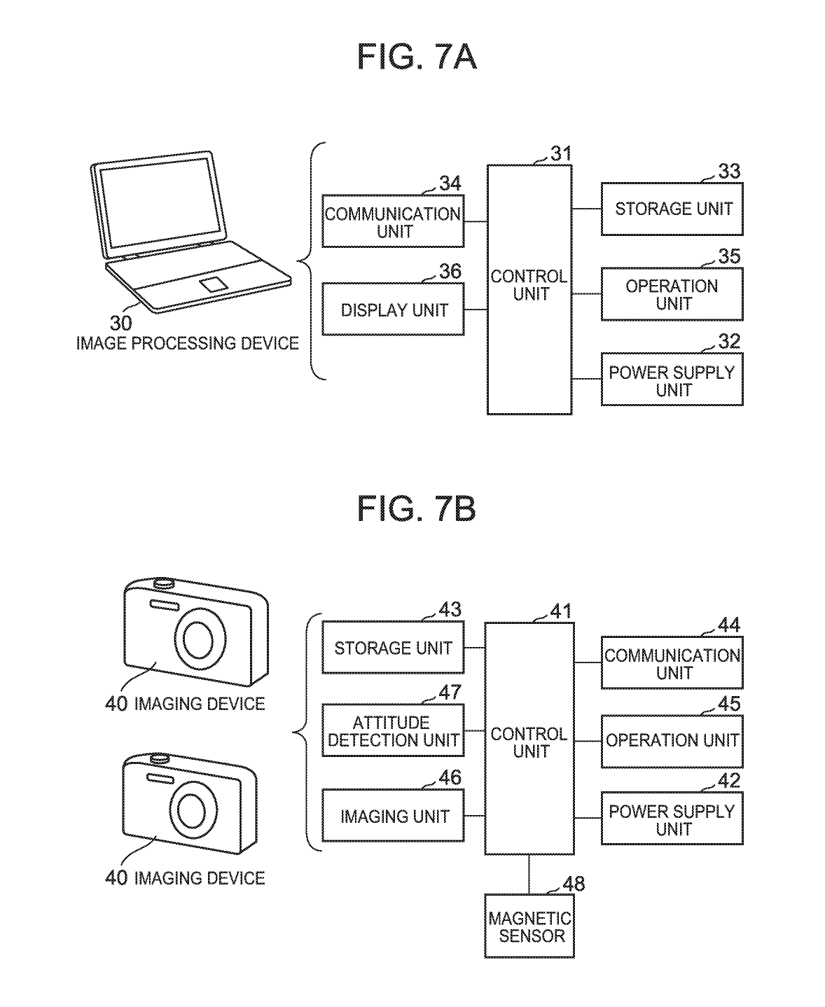

A second embodiment of this invention will be described below with reference to FIG. 7 to FIG. 10.

In the first embodiment mentioned above, a synthetic format is determined at the time of shooting to perform synthesis processing and record/store a synthesized image. On the other hand, in this second embodiment, the present invention is applied to a laptop PC (Personal Computer) 30 as an image processing device. When acquiring and displaying recorded images (stored images) shot by imaging devices (digital cameras) 40, this PC determines a synthetic format to perform synthesis processing so as to display the synthesized image. Here, the same reference numerals are given to basically or denominatively the same components in both embodiments to omit the description. In the following, description will be made by focusing on the features of the second embodiment.

FIG. 7 is a block diagram illustrating schematic configurations of an image processing device (PC) 30 and each of imaging devices (digital cameras) 40.

Since the image processing device (PC) 30 and the imaging devices (digital cameras) 40 have basically the same configurations of the imaging devices 10 and the main body device 20 illustrated in the first embodiment, the detailed description thereof will be omitted. FIG. 7A illustrates the configuration of the image processing device 30, where the image processing device 30 includes a control unit 31, a power supply unit 32, a storage unit 33, a communication unit 34, an operation unit 35, and a display unit 36. FIG. 7B illustrates the configuration of each imaging device 40, where the imaging device 40 includes a control unit 41, a power supply unit 42, a storage unit 43, a communication unit 44, an operation unit 45, an imaging unit 46 with a fisheye lens, an attitude detection unit 47, and a magnetic sensor 48.

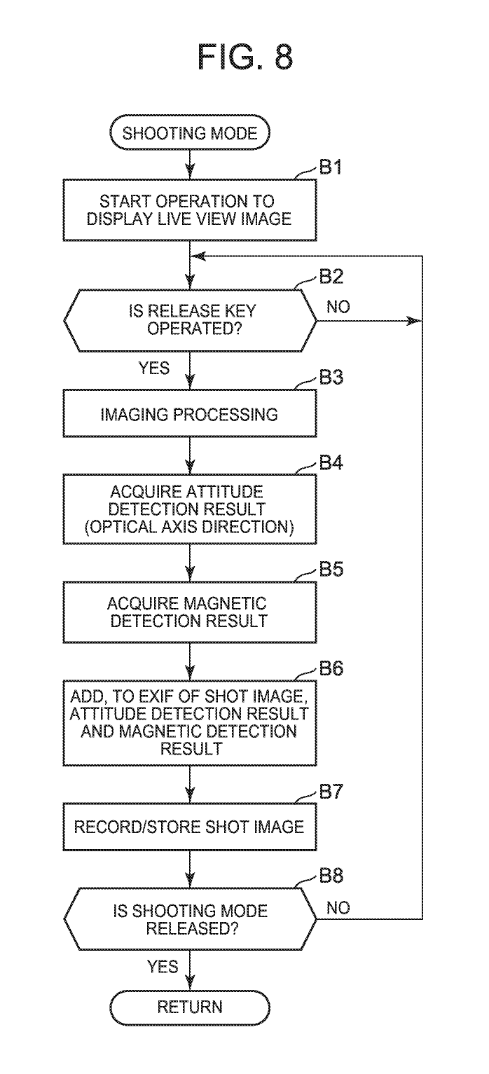

FIG. 8 is a flowchart for describing operation (featured operation of the second embodiment) started upon switching to a shooting mode on the side of the imaging device 40.

First, the control unit 41 of the imaging device 40 starts operation to display, as a live view image, a fisheye image acquired from the imaging unit 46 with the fisheye lens (step B1). In this state, when the release key is operated (YES in step B2), the procedure proceeds to step B3 to acquire a captured image at the time of the release key operation, perform development processing and processing for conversion to a standard-sized file.

Then, the control unit 41 acquires attitude information (optical axis direction) from the attitude detection unit 47 (step B4), and acquires the detection result from the magnetic sensor 48 (step B5). The attitude information (optical axis direction) and the magnetic sensor detection result are added to the shot image as EXIF information thereof (step B6), and recorded/stored on a recording medium in the storage unit 43 (step B7). After that, it is checked whether the shooting mode is released (step B8), and when the mode remains as the shooting mode (NO in step B8), the procedure returns to step B2 mentioned above to repeat the above-mentioned operation.

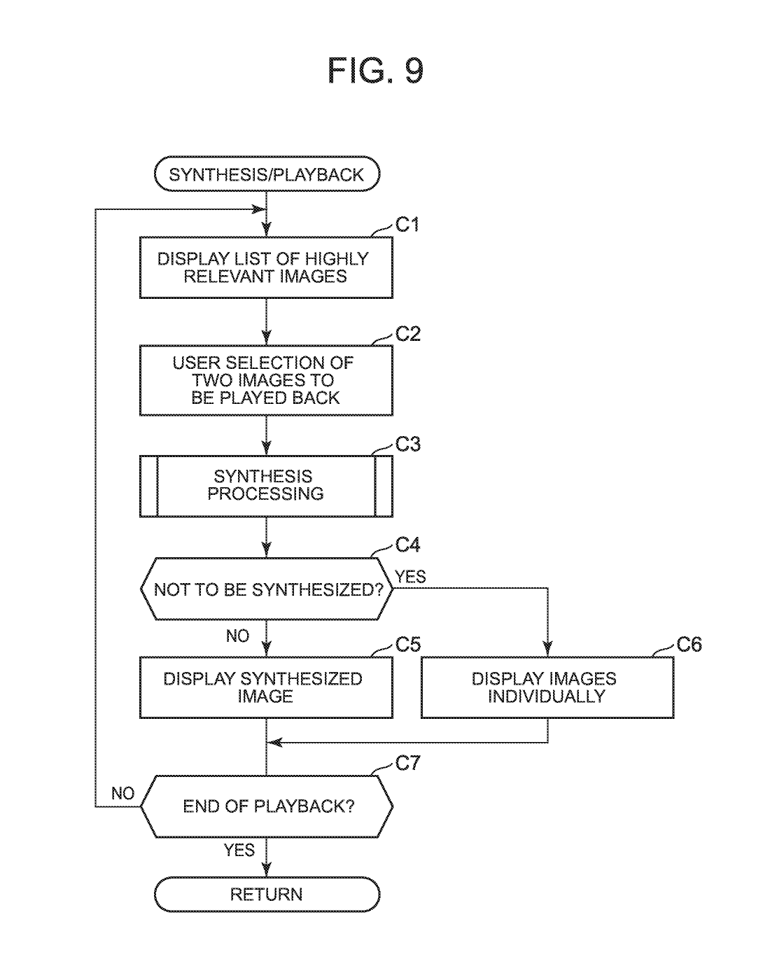

FIG. 9 is a flowchart for describing operation (featured operation of the second embodiment) started when a synthesis/playback mode to synthesize two images and playback a synthesized image on the side of the image processing device 30 is specified with a user's operation.

First, when the synthesis/playback mode for generating and playing back a synthesized image is specified with the user's operation, the control unit 31 of the image processing device 30 displays a list of various images. In this case, a list of pairs of images associated with each other as synthetic targets is displayed (step C1). In other words, the control unit 31 refers to EXIF information (shooting date and time) on each image to identify images with the same shooting date and time as highly relevant images so as to display a list of pairs of relevant images in association with each other. When any two images are selected from this list screen with a user's operation (step C2), the procedure proceeds to the next step C3 to perform processing to synthesize the two images.

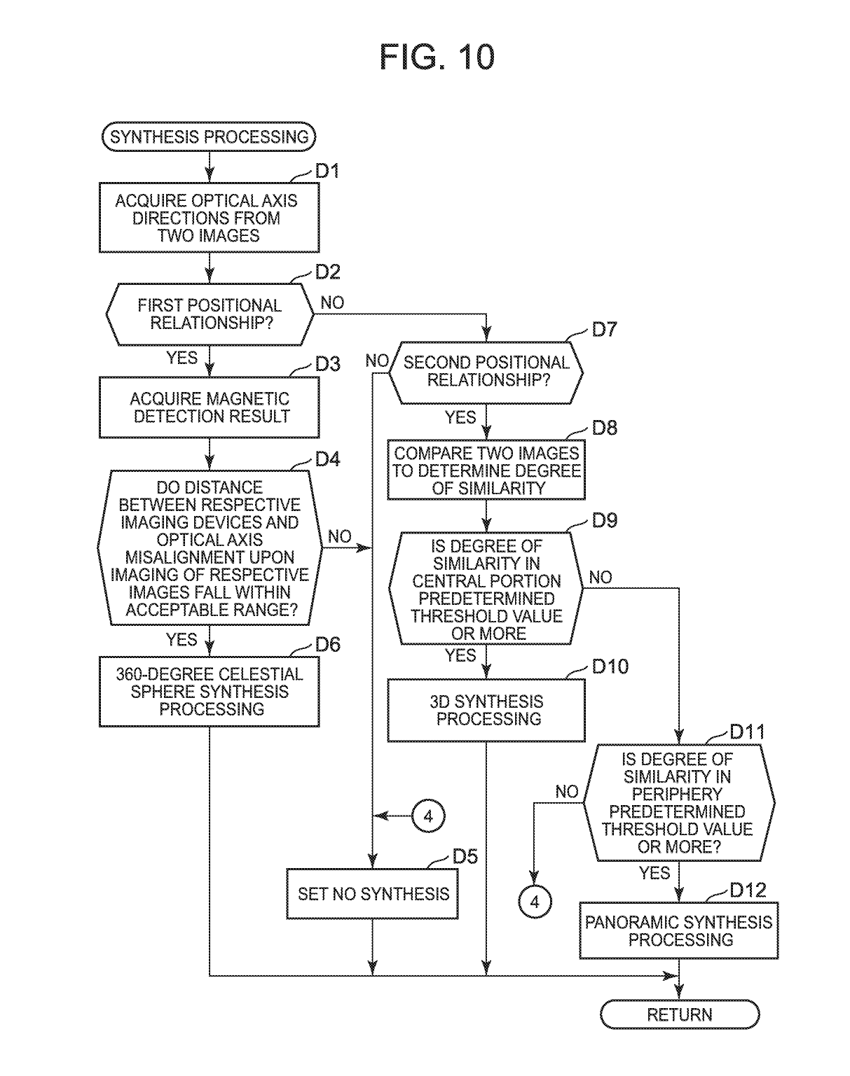

FIG. 10 is a flowchart for describing the synthesis processing (step C3 in FIG. 9) in detail.

First, the control unit 31 acquires EXIF information (optical axis direction) from each image selected with the user's operation (step D1) to check, based on respective optical axis directions, whether the optical axis directions of the respective imaging devices 40 were in the first positional relationship (opposite positional relationship) at the time of shooting (step D2). Here, when it is determined that the shooting was performed in the first positional relationship (YES in step D2), the control unit 31 acquires the magnetic sensor detection results (intensity and direction of the magnetic field) from the EXIF information on the respective images (step D3), and based on the detection results (intensity and direction of the magnetic field), checks not only whether the respective imaging devices 40 were too far away from each other (i.e., the respective imaging devices 40 fell within an acceptable range), but also whether the optical axis misalignment thereof fell within an acceptable range (step D4).

In the first positional relationship, when it is determined that the shooting was performed in such a condition that the respective imaging devices 40 were too far away from each other and the optical axis misalignment was too much (NO in step D4), a nonsynthetic flag (not illustrated) is set (turned on) not to target the selected two images for synthesis processing (step D5). Further, in the first positional relationship, when it is determined that the shooting was performed in such a condition that the distance between the respective imaging devices 40 and the optical axis misalignment fell within the acceptable ranges (YES in step D4), it is determined that the shooting was performed in such a condition that the backsides of the respective imaging devices 40 were in contact with or came close to each other. In this case, the procedure proceeds to step D6 to specify the selected two images as targets of synthesis processing in order to perform processing for 360-degree celestial sphere synthesis of the two images.

On the other hand, when the optical axis directions of the respective imaging devices 40 were not in the first positional relationship (NO in step D2), it is checked whether the respective imaging devices 40 were in the second positional relationship (same-direction positional relationship) (step D7). When the respective imaging devices 40 were not in the second positional relationship as well (NO in step D7), the selected two images are set not to be synthesized (step D5), while when the respective imaging devices 40 were in the second positional relationship (YES in step D7), the selected two images are analyzed and the analysis results are compared to determine the degree of similarity between both (step D8) in order to check whether the degree of similarity between central portions of the two images is a predetermined threshold value or more (whether the degree of similarity is high) (step D9). Here, when the degree of similarity between the central portions of the two images is the predetermined threshold value or more and hence the degree of similarity is high (YES in step D9), the procedure proceeds to step D10 to specify the selected two images as targets for synthesis processing in order to perform processing for 3D synthesis of the two images.

Further, in the second positional relationship (YES in step D7), when the degree of similarity between the central portions of the two images is less than the predetermined threshold value and hence the degree of similarity between the portions is not high (NO in step D9), it is checked whether the degree of similarity between the peripheries of the two images is a predetermined threshold value or more (whether the degree of similarity is high) (step D11). Here, when the degree of similarity between the peripheries is also less than the predetermined threshold value (NO in step D11), each image is set not to be synthesized (step D5), while when the degree of similarity between the peripheries is the predetermined threshold value or more and hence the degree of similarity is high (YES in step D11), the procedure proceeds to step D12 to specify the selected two images as targets for synthesis processing in order to perform processing for panoramic synthesis of the two images.

When such synthesis processing (step C3 in FIG. 9) is completed, the procedure proceeds to the next step C4 to check whether the nonsynthetic flag mentioned above is turned on, i.e., whether no synthesis is set. When the nonsynthetic flag is turned on (YES in step C4), playback processing for displaying the selected images individually is performed (step C6). In this case, the two images selected as synthetic targets are specified sequentially, and switched and displayed every fixed time interval. When no synthesis is not set (NO in step C4), the procedure proceeds to processing for displaying an image synthesized by the synthesis processing (step C5). Then, it is checked whether the end of playback is instructed with a user's operation (step C7). When the end of playback is instructed (YES in step C7), the procedure exits from the flow of FIG. 9, while when the end of playback is not instructed (NO in step C7), the procedure returns to step C1 mentioned above to repeat the above-mentioned operation.

As described above, in the second embodiment, since the control unit 31 of the image processing device 30 performs control to acquire plural images, evaluate the supplementary information (EXIF information), and determine, based on the evaluation results, whether to set a synthetic format corresponding to the evaluation results to use the plural images as synthesis processing target images, or to set the plural images not to be synthesized without being targeted for the synthesis processing, the determination of whether to obtain a special-effect shot image shot can be easily controlled without any instruction given with a user's operation at the time of image playback. Thus, images shot using various special effects and other normal images can be easily obtained.

In the second embodiment mentioned above, when a list of pairs of associated images as synthetic targets is displayed in association with each other in the synthesis/playback mode to generate and play back a synthesized image, the shooting date and time are referred to identify the associated images, but shooting positions added to shot images may be referred to identify, as associated images, respective images whose shooting positions coincide with or close to each other.

### Third Embodiment

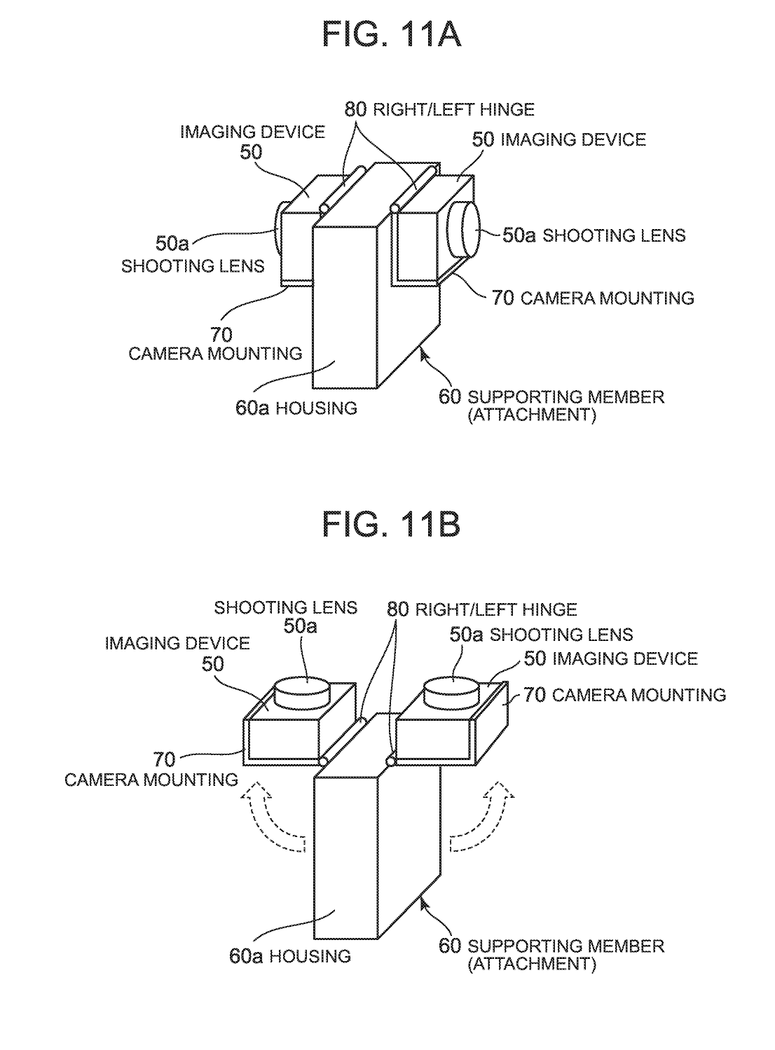

A third embodiment of this invention will be described below with reference to FIG. 11 to FIG. 14.

In the first and second embodiments, the two imaging devices 10, 40 are cameras capable of moving freely and independently, but in the third embodiment, two imaging devices 50 are attached to an image processing device (supporting device) 60, where the two imaging devices 50 are attached to the image processing device (supporting device) 60 in such a manner that the relative positional relationship can be changed. This image processing device (supporting device) 60 is a compact electronic device that constitutes an attachment for supporting the two imaging devices 50.

FIG. 11 is an appearance diagram illustrating a schematic configuration of the image processing device (supporting device: attachment) that supports the two imaging devices (digital cameras) 50.

Each of the imaging devices 50 is formed of a box-shaped housing as a whole, and mounted on a camera mounting 70. In other words, the imaging device 50 is fixedly mounted in such a manner that the backside (the side opposite to an imaging lens 50a) and the bottom side thereof will come into surface contact with the camera mounting 70 having an L-shaped cross section. A housing 60a of the supporting device 60 is formed into a thick-plate like rectangular parallelepiped as a whole, and the imaging devices 50 fixedly mounted on the camera mounting 70 are attached to (supported by) both sides of the housing 60a in the thickness (right-and-left) direction thereof openably/closably through a pair of right and left hinges 80. This pair of right and left hinges 80 is a shaft-like opening/closing member fixedly arranged along the edges between the top faces and the right/left side faces of the supporting device 60, and a supporting member that supports the two imaging devices 50 to be variable (openable/closable) within a positional relationship range (0 to 90 degrees) from a positional relationship, in which the optical axis directions of the two imaging devices 50 are opposite to each other, to a positional relationship, in which the optical axis directions become the same directions. The housing 60a of the supporting device 60 and the pair of right and left hinges 80 constitute a supporting member that supports the two imaging devices 50.

FIG. 11A illustrates a positional relationship in which the two imaging devices 50 are closed, i.e., the optical axis directions of the two imaging devices 50 are opposite to each other, and FIG. 11B illustrates a positional relationship in which the two imaging devices 50 are opened, i.e., the optical axis directions of the two imaging devices 50 are the same directions, where the two imaging devices 50 are displaceable within the range of opening/closing angles (0 to 90 degrees). Although the two imaging devices 50 are displaceable in multiple steps within the range of opening/closing angles of 0 to 90 degrees (e.g., in 18 steps of 5 degrees), the pair of right and left hinges 80 are constructed to be able to retain the two imaging devices 50 at each step position.

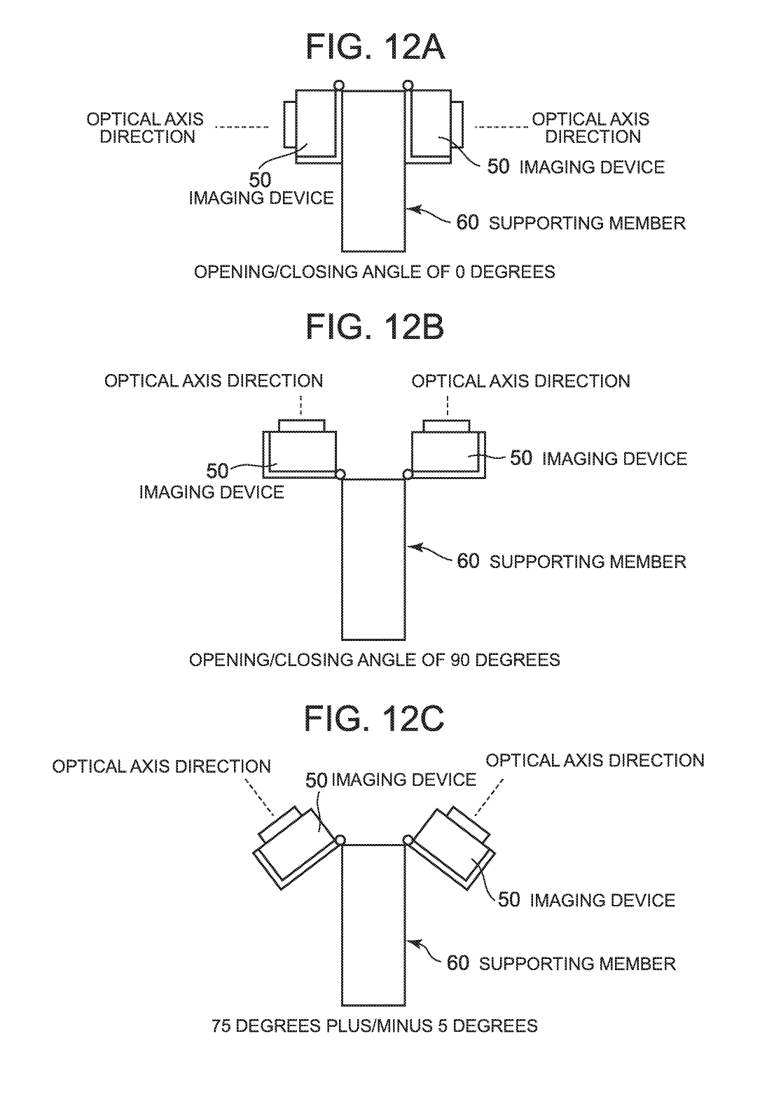

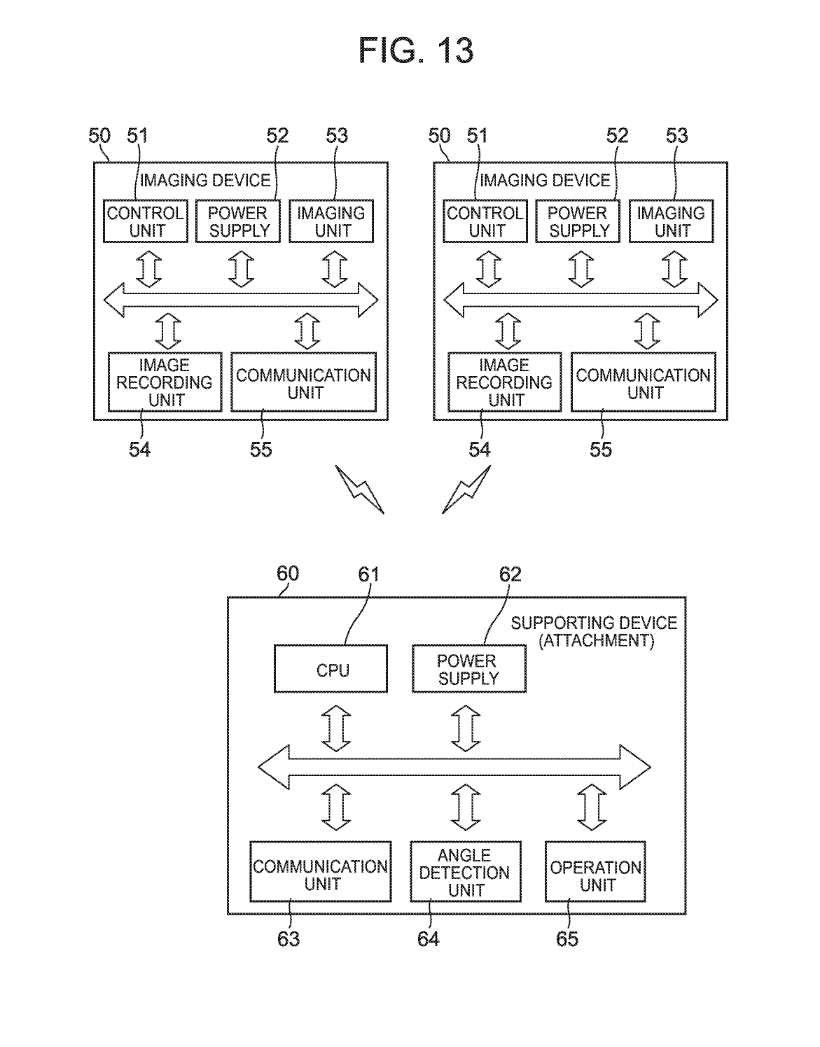

The supporting device (attachment) 60 includes an angle detection unit (see FIG. 13 to be described later) that detects an opening/closing angle (0 to 90 degrees) of the imaging devices 50. This angle detection unit is to detect a displacement (opening/closing angle) between the two imaging devices 50 supported by the supporting device 60, and the supporting device 60 determines, based on the detection result of this angle detection unit, whether the relative positional relationship (opening/closing angle) of the two imaging devices 50 is a predetermined positional relationship. When the relative positional relationship is the predetermined positional relationship, respective images shot in the positional relationship are targeted for synthesis processing and the synthetic format is set, while when the relative positional relationship is not the predetermined positional relationship, respective images shot in the positional relationship is set not to be synthesized without being targeted for the synthesis processing. FIGS. 12A to 12C are diagrams illustrating a first positional relationship to a third positional relationship as predetermined positional relationships (opening/closing angles).

In other words, FIG. 12A illustrates an arrangement relationship (first positional relationship) in which the optical axis directions of the imaging devices 50 become the opposite directions or directions within an acceptable range with respect to the opposite directions, where the opening angle of the optical axis directions of the imaging devices 50 in this first positional relationship is 0 degrees. FIG. 12B illustrates an arrangement relationship (second positional relationship) in which the optical axis directions of the imaging devices 50 become the same directions or directions within an acceptable range with respect to the same direction, where the opening angle of the optical axis directions of the imaging devices 50 in this second positional relationship is 90 degrees. FIG. 12C illustrates an arrangement relationship (third positional relationship) in which the optical axis directions of the imaging devices 50 become predetermined intermediate directions between the first positional relationship and the second positional relationship or directions within an acceptable range with respect to the intermediate directions, where the opening angle of the optical axis directions of the imaging devices 50 in this third positional relationship is 75 degrees plus/minus 5 degrees. In the third embodiment, the first to third positional relationships are determined to be predetermined positional relationships.

FIG. 13 is a block diagram illustrating schematic configurations of the two imaging devices 50 and the supporting device 60.

Since each imaging device 50 has basically the same configuration as that of each imaging device 10 illustrated in the first embodiment, the detailed description will be omitted. As illustrated in FIG. 13, the imaging device 50 includes a control unit 51, a power supply unit 52, an imaging unit 53, an image storage unit 54, a communication unit 55, and the like. FIG. 13 also illustrates the configuration of the supporting device 60, where the supporting device 60 includes a CPU 61, a power supply unit 62, a communication unit 63, an angle detection unit 64, an operation unit 65, and the like.

The communication unit 63 is a short-distance communication unit that receives shot images from the two imaging devices 50 and transmits acquired shot images to the two imaging devices 50. The angle detection unit 64 is a sensor that detects an opening/closing angle (0 to 90 degrees) of the respective imaging devices 50, which is adapted to detecting an angle within a range of 0 to 90 degrees, for example, at a pitch of 5 degrees. Though not illustrated in the figure, the operation unit 65 includes a release key, an opening/closing adjustment key for the imaging devices 50, and the like. When the release key is operated, the CPU 61 transmits a shooting instruction to the two imaging devices 50 at the same time, while when the opening/closing adjustment key is operated, the opening/closing angle of the two imaging devices 50 is displaced in the forward direction (a direction from 0 to 90 degrees) or in the backward direction (from 90 to 0 degrees) in a stepwise fashion.

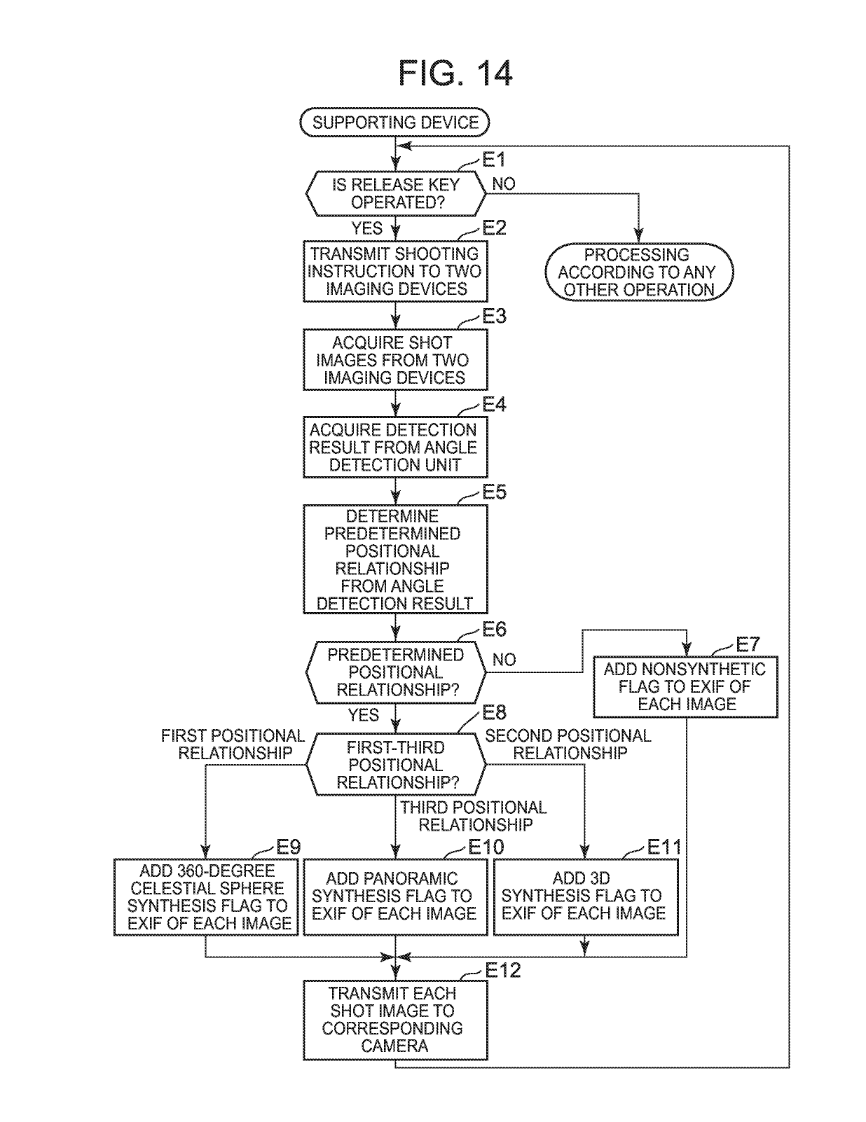

FIG. 14 is a flowchart illustrating operation on the side of the supporting device 60 (featured operation of the third embodiment) started each time shooting is performed on the side of the imaging devices 50.

First, the supporting device 60 checks whether the release key is operated (step E1). When the release key is not operated (NO in step E1), the procedure moves to processing corresponding to the operation key, while when the release key is operated (YES in step E1), the supporting device 60 transmits a shooting instruction to the two imaging devices 50 at the same time (step E2). Then, shot images are acquired (received) from the two imaging devices 50 (step E3), and the opening/closing angle at the time of shooting is acquired from the angle detection unit 64 (step E4). Then, based on this detection result of the angle detection unit 64, it is determined whether the relative positional relationship (opening/closing angle) of the two imaging devices 50 is a predetermined positional relationship (any of the first to third positional relationships) (step E5).

When the relative positional relationship of the two imaging devices 50 is not the predetermined positional relationship (NO in step E6), a flag to give an instruction of no synthesis is added to EXIF information on each shot image (step E7), while when the relative positional relationship is the predetermined positional relationship (YES in step E6), it is determined whether the relative positional relationship is any of the first to third positional relationships (step E8). Here, when the relative positional relationship is the first positional relationship (0 degrees), a flag to give an instruction of 360-degree celestial sphere synthesis processing is added to the EXIF information on each shot image (step E9). When the relative positional relationship is the second positional relationship (90 degrees), a flag to give an instruction of 3D synthesis processing is added to the EXIF information on each shot image (step E11). When the relative positional relationship is the third positional relationship (75 degrees plus/minus 5 degrees), a flag to give an instruction of panoramic synthesis processing is added to the EXIF information on each shot image (step E10). Then, each shot image with the above-mentioned flag added is transmitted to a corresponding imaging device 50 to record/store the shot image (step E12). After that, the procedure returns to step E1 mentioned above.

When shot images with a flag to give an instruction of synthesis processing are received from the supporting device 60, the shot images are developed, and recorded/stored on the side of the imaging devices 50. In doing so, EXIF information (flag) on the shot images is referred to determine a synthetic format and perform synthesis processing according to the synthetic format to generate a synthesized image. Then, this synthesized image is developed, and recorded/stored together with the shot images mentioned above.

As described above, in the third embodiment, the supporting device (attachment) 60 supports the two imaging devices 50 to make the two imaging devices 50 displaceable between a positional relationship, in which the optical axis directions become opposite directions, and a positional relationship in which the optical axis directions become the same directions, and determines, based on the displacement (opening/closing angle) of the two imaging devices 50, whether the relative positional relationship of the respective imaging devices 50 is a predetermined positional relationship. When the relative positional relationship is the predetermined positional relationship, each image shot in the positional relationship is targeted for synthesis processing and the synthetic format is set, while when the relative positional relationship is not the predetermined positional relationship, each image shot in the positional relationship is set not to be synthesized without being targeted for the synthesis processing. Therefore, the determination of whether to obtain a special-effect image can be easily controlled without any instruction given with a user's operation. This enables the supporting device 60 to cope with shooting using various special effects and other normal shooting.

Further, since the first positional relationship in which the optical axis directions of the respective imaging devices 50 become the opposite directions or directions within an acceptable range with respect to the opposite directions, the second positional relationship in which the optical axis directions of the respective imaging devices 50 become the same directions or directions within an acceptable range with respect to the same direction, and the third positional relationship in which the optical axis directions of the respective imaging devices 50 become predetermined intermediate directions between the first positional relationship and the second positional relationship or directions within an acceptable range with respect to the intermediate directions are determined to be predetermined positional relationships, the relative positional relationship of the respective imaging devices 50 becomes a positional relationship suitable for 360-degree celestial sphere synthesis, 3D synthesis, or panoramic synthesis, and easy for the user to understand.

In the third embodiment mentioned above, EXIF information (flag) on shot images is referred to determine a synthetic format at the time or recording/storing the shot images, and perform synthesis processing according to the synthetic format in order to record/store a synthesized image, but EXIF information (flag) on recorded images (stored images) may be referred to determine a synthetic format at the time of image playback, and perform synthesis processing according to the synthetic format in order to play back a synthesized image.

In the third embodiment mentioned above, the supporting device 60 determines a synthetic format and adds the synthetic format to each image, but an image synthesis function may be provided in the supporting device 60 to perform synthesis processing according to the synthetic format in order to generate the synthesized image. This enables various special-effect images to be obtained easily. Note that the configuration of the supporting device 60 is optional, and the mounting positions of the imaging devices 50 are also optional.

<Variation 2>

In the first and second embodiments mentioned above, the imaging devices 10, 40 detect the optical axis directions thereof based on the detection results of the attitude detection unit 17 or the attitude detection unit 47. Further, in the third embodiment, the optical axis directions of the imaging devices 50 are detected based on the detection results of the angle detection unit 64 in the supporting device 60. However, instead of detecting the optical axis directions of the imaging devices using a sensor, images may be analyzed to determine the optical axis directions.

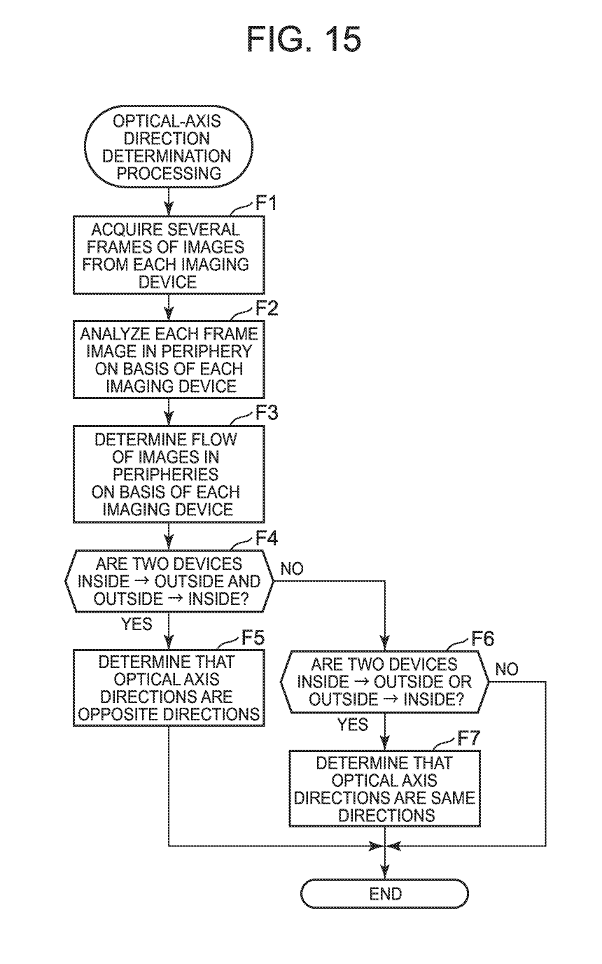

FIG. 15 is a flowchart illustrating processing for determining the optical axis directions by image analysis, where moving images captured using fisheye lenses are exemplified. However, the images are not limited to the moving images, and the images may be still images continuously captured at high speed.

An image processing device (e.g., a PC, a camera, or a supporting device) acquires several frames of images from two imaging devices (step F1), analyzes each frame image on a basis of each imaging device (step F2), and determines flows of images in the central portions and peripheries (step F3).

Here, when a flow of one of the two imaging devices is from the center to the periphery (from inside to outside) and a flow of the other is from the periphery to the center (from outside to inside) (YES in step F4), it is determined that the optical axis directions of the two imaging devices are opposite directions (step F5). Further, when flows of the two imaging devices are both from the center to the periphery (from inside to outside) or both from the periphery to the center (from outside to inside) (YES in step F6), it is determined that the optical axis directions of the two imaging devices are the same directions (step F7).

Thus, plural frames of images have only to be acquired from the two imaging devices and analyzed to enable the optical axis directions of the two imaging devices to be detected from flows of the images.

Further, in each of the aforementioned embodiments, it is determined whether the relative positional relationship of the respective imaging devices is a predetermined positional relationship, and when it is the predetermined positional relationship, each image shot in the positional relationship is targeted for synthesis processing and the synthetic format is set. However, when the relative positional relationship is the predetermined positional relationship, shooting conditions, such as the zoom magnification and the focal length being set, may be further acquired from each imaging device to determine whether the shooting conditions are suitable for synthesis processing. In this case, when the shooting conditions become adapted, a synthetic format may be set according to the predetermined positional relationship. This enables the synthesis processing to be performed properly.

Further, in each of the aforementioned embodiments, it is determined whether the relative positional relationship of respective imaging devices is a predetermined positional relationship, and when it is the predetermined positional relationship, each image shot in the positional relationship is targeted for synthesis processing and the synthetic format is set. However, when the relative positional relationship is the predetermined positional relationship, shooting conditions such as the zoom magnification and the focal length of each imaging device may be set as conditions suitable for each synthetic format. This enables synthesis processing to be performed on images captured on more suitable imaging conditions.

Further, in each of the aforementioned embodiments, a suitable synthetic format is set from the optical axis directions of and positional relationship/distance between respective imaging devices, but the synthetic format may be set only from the positional relationship of the respective imaging devices.

For example, each imaging device may be an imaging device capable of shooting around regardless of the imaging direction like an imaging device capable of 360-degree celestial sphere shooting. In such a case, when the relative positional relationship is a predetermined positional relationship, a required part of each image shot as the 360-degree celestial sphere may be clipped from the image according to a synthetic format, while in each of the aforementioned embodiments, it is determined whether the relative positional relationship is a predetermined positional relationship, and when it is the predetermined positional relationship, each image shot in the positional relationship is targeted for synthesis processing and a synthetic format is set for each image. This enables the synthetic format to be set from the captured image without defining the angle of view.

In each of the aforementioned embodiments, the present invention is applied to a PC, a camera, or a supporting device as the image processing device, but the present invention is not limited thereto. The image processing device may be a PDA (Personal Digital Assistant), a tablet terminal device, a mobile phone such as a smartphone, a computerized gaming machine, a music player, or the like.

The term “device” or “unit” illustrated in the each of the aforementioned embodiments is not limited to a single housing, and the “device” or “unit” may be separated into two or more housings depending on the functions. Further, each step described in the flowcharts mentioned above is not limited to a time-series process, and two or more steps may be executed in parallel or executed separately and independently.

While the embodiments of this invention are described above, this invention is not limited to the embodiments, and inventions as set forth in claims and equivalents thereof shall be included.

### DESCRIPTION OF REFERENCE NUMERALS

10, 40, 50 imaging device
11, 21, 31, 61 control unit
13, 23, 33, 63 storage unit
16, 46, 53 imaging unit
17, 47 attitude detection unit
18, 28 magnetic sensor
20 image processing device (main body device)
30 image processing device (PC)
60 image processing device (supporting device)
64 angle detection unit
80 right/left hinge

What is claimed is:

1. An image processing device including a processor, wherein the processor executes:
acquiring position information related to a positional relationship between a first imaging device and a second imaging device;
determining, based on the acquired position information, whether a relative positional relationship between the first imaging device and the second imaging device satisfies a predetermined condition; and
when the relative positional relationship is determined to be satisfied the predetermined condition, setting a synthetic format for respective images captured by the first imaging device and the second imaging device in the positional relationship, wherein the synthetic format is used for synthesizing the respective images.

2. The image processing device according to claim 1, wherein the processor
acquires optical axis information related to optical axis directions of the first imaging device and the second imaging device, and
determines, based on the optical axis information and the position information, whether the relative positional relationship between the first imaging device and the second imaging device satisfies the predetermined condition.

3. The image processing device according to claim 2, wherein the processor determines whether the relative positional relationship is a first positional relationship, in which the optical axis directions of the first imaging device and the second imaging device become opposite directions or directions within an acceptable range with respect to the opposite directions, or a second positional relationship, in which the optical axis directions of the first imaging device and the second imaging device become same directions or directions within an acceptable range with respect to the same direction.

4. The image processing device according to claim 2, wherein the processor further acquires information related to an optical axis misalignment between the first imaging device and the second imaging device, and when the relative positional relationship is determined to be a first positional relationship, in which the optical axis directions of the first imaging device and the second imaging device become opposite directions or directions within an acceptable range with respect to the opposite directions, the processor further determines whether the misalignment falls within an acceptable range based on the acquired information related to the optical axis misalignment, and when the misalignment falls within the acceptable range, the processor determines that the relative positional relationship satisfies the predetermined condition.

5. The image processing device according to claim 2, wherein when the relative positional relationship is determined to be a second positional relationship, in which the optical axis directions of the first imaging device and the second imaging device become same directions or directions within an acceptable range with respect to the same direction, the processor further determines whether distance between the first imaging device and the second imaging device falls within an acceptable range, and when the distance falls within the acceptable range, the processor determines that the relative positional relationship satisfies the predetermined condition.

6. The image processing device according to claim 5, wherein the processor obtains a degree of similarity between respective images captured by the first imaging device and the second imaging device, and when the relative positional relationship is determined to be the second positional relationship, in which the optical axis directions of the first imaging device and the second imaging device become same directions or directions within the acceptable range with respect to the same direction, the processor further determines, based on the obtained degree of similarity, whether distance between the first imaging device and the second imaging device falls within an acceptable range, and when the distance falls within the acceptable range, the processor determines that the relative positional relationship satisfies the predetermined condition.

7. The image processing device according to claim 6, wherein when a degree of similarity between central portions of images captured by the first imaging device and the second imaging device is high, the processor determines that the distance between the first imaging device and the second imaging device falls within the acceptable range.

8. The image processing device according to claim 6, wherein when a degree of similarity between peripheries of images captured by the first imaging device and the second imaging device is high, the processor determines that the distance between the first imaging device and the second imaging device falls within the acceptable range.

9. The image processing device according to claim 4, wherein
the first imaging device and the second imaging device are provided with respective fisheye lenses, and
when the relative positional relationship is determined to be the first positional relationship, and further when the acquired optical axis misalignment falls within the acceptable range, the processor sets a synthetic format to generate a 360-degree celestial sphere image from respective fisheye images captured by the first imaging device and the second imaging device.

10. The image processing device according to claim 5, wherein when the relative positional relationship is determined to be the second positional relationship, and further when the distance between the first imaging device and the second imaging device falls within the acceptable range, the processor sets a synthetic format corresponding to a length of the distance to generate a panoramic image or a three dimensional image from respective images captured by the first imaging device and the second imaging device.

11. The image processing device according to claim 1, wherein the processor
acquires shooting conditions from the first imaging device and the second imaging device, and
when the relative positional relationship is determined to be satisfied the predetermined condition, and when the acquired shooting conditions are adapted to synthesis processing, sets a synthetic format for the synthesis processing.

12. The image processing device according to claim 1, wherein the processor
performs synthesis processing on respective images captured by the first imaging device and the second imaging device, and
performs synthesis processing on each image based on the set synthetic format.

13. The image processing device according to claim 2, wherein the processor acquires the information related to optical axis directions from attitude detection units respectively provided in the first imaging device and the second imaging device.

14. The image processing device according to claim 2, wherein
the first imaging device and the second imaging device capture images continuously using fisheye lenses, and
the processor analyzes images continuously captured by the first imaging device and the second imaging device to acquire information related to optical axis directions from motion of a subject.

15. The image processing device according to claim 2, wherein
the image processing device includes the first imaging device, and
the processor acquires information related to an optical axis direction from the first imaging device, and acquires information related to an optical axis direction from the second imaging device provided in another image processing device different from the image processing device.

16. The image processing device according to claim 1, further including
a supporting member that supports the first imaging device and the second imaging device to make the optical axis directions of the first imaging device and the second imaging device displaceable,
wherein the processor determines, based on a displacement between the first imaging device and the second imaging device supported by the supporting member, whether the relative positional relationship between the first imaging device and the second imaging device satisfies the predetermined condition.

17. The image processing device according to claim 16, wherein
the supporting member supports the first imaging device and the second imaging device to make the relative positional relationship between the first imaging device and the second imaging device displaceable between a positional relationship, in which the optical axis directions of the first imaging device and the second imaging device become opposite directions, and a positional relationship in which the optical axis directions become same directions, and
the processor determines, to be satisfied the predetermined condition, a first positional relationship, in which the optical axis directions of the first imaging device and the second imaging device become opposite directions or directions within an acceptable range with respect to the opposite directions, a second positional relationship, in which the optical axis directions of the first imaging device and the second imaging device become same directions or directions within an acceptable range with respect to the same direction, or a third positional relationship, in which the optical axis directions of the first imaging device and the second imaging device become predetermined intermediate directions between the first positional relationship and the second positional relationship or directions within an acceptable range with respect to the intermediate directions.

18. The image processing device according to claim 2, wherein the processor
acquires plural images,
acquires the optical axis information and the position information from the plural images acquired, and
determines whether the relative positional relationship between the first imaging device and the second imaging device satisfies the predetermined condition.

19. An image processing method used in an image processing device, comprising:
acquiring position information related to a positional relationship between a first imaging device and a second imaging device;
determining, based on the acquired position information, whether a relative positional relationship between the first imaging device and the second imaging device satisfies a predetermined condition; and
when the relative positional relationship is determined to be satisfied the predetermined condition, setting a synthetic format for respective images captured by the first imaging device and the second imaging device in the positional relationship, wherein the synthetic format is used for synthesizing the respective images.

20. A non-transitory recording medium on which a computer-readable program is recorded, the program causing a computer to execute:
acquiring position information related to a positional relationship between a first imaging device and a second imaging device;
determining, based on the acquired position information, whether a relative positional relationship between the first imaging device and the second imaging device satisfies a predetermined condition; and
when the relative positional relationship is determined to be satisfied the predetermined condition, setting a synthetic format for respective images captured by the first imaging device and the second imaging device in the positional relationship, wherein the synthetic format is used for synthesizing the respective images.
